(19) United States
(12) Patent Application Publication
(10) Pub. No.: US 2009/0055368 A1
(43) Pub. Date: Feb. 26, 2009

(54) CONTENT CLASSIFICATION AND EXTRACTION APPARATUS, SYSTEMS, AND METHODS

(76) Inventors: Gaurav Rewari, Cupertino, CA (US); Sadanand Sahasrabudhe, Gaithersburg, MD (US); Prashant Rao, San Mateo, CA (US); Kenneth Jamora, San Francisco, CA (US); David Cooke, Lost Altos, CA (US)

Correspondence Address: SCHWEGMAN, LUNDBERG & WOESSNER, P.A., P.O. BOX 2938, MINNEAPOLIS, MN, 55402, US

(21) Appl. No.: 11/844,825

(22) Filed: Aug. 24, 2007

(51) Int. Cl. G06F 17/30

(52) U.S. Cl. 707/4; 707/E17.014

(57) ABSTRACT

Embodiments herein relate market entities, market topics, and market relationships in a market relationship module (MRM). The MRM is used to index user-applicable information content and to formulate queries for later recall and presentation of the applicable content. Other embodiments are described and claimed.

### RELATED APPLICATIONS

This disclosure is related to pending U.S. patent application Ser. No. ______, titled “Content Identification and Classification Apparatus, Systems, and Methods,” attorney docket No. 2478.001US1, filed on Aug. 24, 2007, assigned to the assignee of the embodiments disclosed herein, firstRain Inc., and is incorporated herein by reference in its entirety.

### TECHNICAL FIELD

Various embodiments described herein relate to information access generally, including apparatus, systems, and methods used in information content classification and extraction.

### BACKGROUND

The term “market intelligence” refers generally to information that is relevant to a company's markets. Market intelligence may include information about competitors, customers, prospects, investment targets, products, people, industries, regulatory areas, events, and market themes that impact entire sets of companies.

Market intelligence may be gathered and analyzed by companies to support a range of strategic and operational decision making, including the identification of market opportunities and competitive threats and the definition of market penetration strategies and market development metrics, among others. Market intelligence may also be gathered and analyzed by financial investors to aid with investment decisions relating to individual securities and to entire market sectors.

With the explosion of the Internet as a means of reporting and disseminating information, the ability to obtain timely, relevant, hard-to-find intelligence from the World-wide Web (“Web”) has become central to many market intelligence initiatives. This may be particularly important to financial services investment professionals because of government-mandated restrictions on the preferential sharing of information by company management. These issues have resulted in an increased interest in applying technology to provide differentiated data and insights from web-based sources in order to yield trading advantages for investors.

However, efforts to provide timely market intelligence from internet sources have been limited by the scale, complexity, diversity and dynamic nature of the Web and its information sources. The Web is vast, dynamically changing, noisy (containing irrelevant data), and chaotic. These characteristics may confound analytical methods that are successful with structured data and even methods that may be successful with unstructured content found on enterprise intranets.

Unlike structured data in a database, web information tends not to conform to a fixed semantic structure or schema. As a result, such information may not readily lend itself to precise querying or to directed navigation. And unlike most unstructured content on corporate intranets, data on the Web may be far more vast and volatile, may be authored by a much larger and varied set of individuals, and in general may contain less descriptive metadata (or tags) capable of exploitation for the purpose of retrieving and classifying information.

Existing approaches to internet searching are designed to support a wide cross-section of users seeking content across the breadth of all human knowledge. These approaches may not support the specialized needs of market intelligence users. Shortcomings may include the poor quality of the search results as measured by precision and recall, the ineffectiveness of a keyword-based search paradigm in uncovering market intelligence, and the limited ability to place returned results in a context suitable for strategic or investment decision-making. “Precision” as used herein means the proportion of retrieved and relevant documents to all documents retrieved. “Recall” as used herein means the proportion of relevant documents that are retrieved, out of all relevant documents available.

For example, consider a market intelligence query comprising a search for management departures from a particular company in the last six months. Such a query performed by a major internet search engine may not be restricted to management departures from the particular company and may therefore suffer from poor precision. Returned results may exclude some management departures known to exist on the Internet, resulting in poor recall. The latter problem may be caused by certain websites not being included in the results at all, a condition termed “lack of completeness.” The problem may also be characterized by the most recent management departures not being included in the results, a condition termed “lack of freshness.” The latter condition may occur even if the most recent management departures are mentioned in sites that are indexed by the search engine.

### BRIEF DESCRIPTION OF THE DRAWINGS

FIG. 1 illustrates an example apparatus and system according to various embodiments of the invention.

FIGS. 2A-2D illustrate example market entities and market topics in representative market relationships with one another according to various embodiments of the invention.

FIG. 3 depicts an example method applicable to the area of securities asset management.

FIG. 4 illustrates an example user information presentation screen according to various embodiments.

FIG. 5 is a data plane diagram conceptualizing market relationships according to various embodiments of the invention.

FIG. 6 illustrates example methods according to various embodiments of the invention.

FIG. 7 is a block diagram of a computer-readable medium according to various embodiments of the invention.

### DETAILED DESCRIPTION

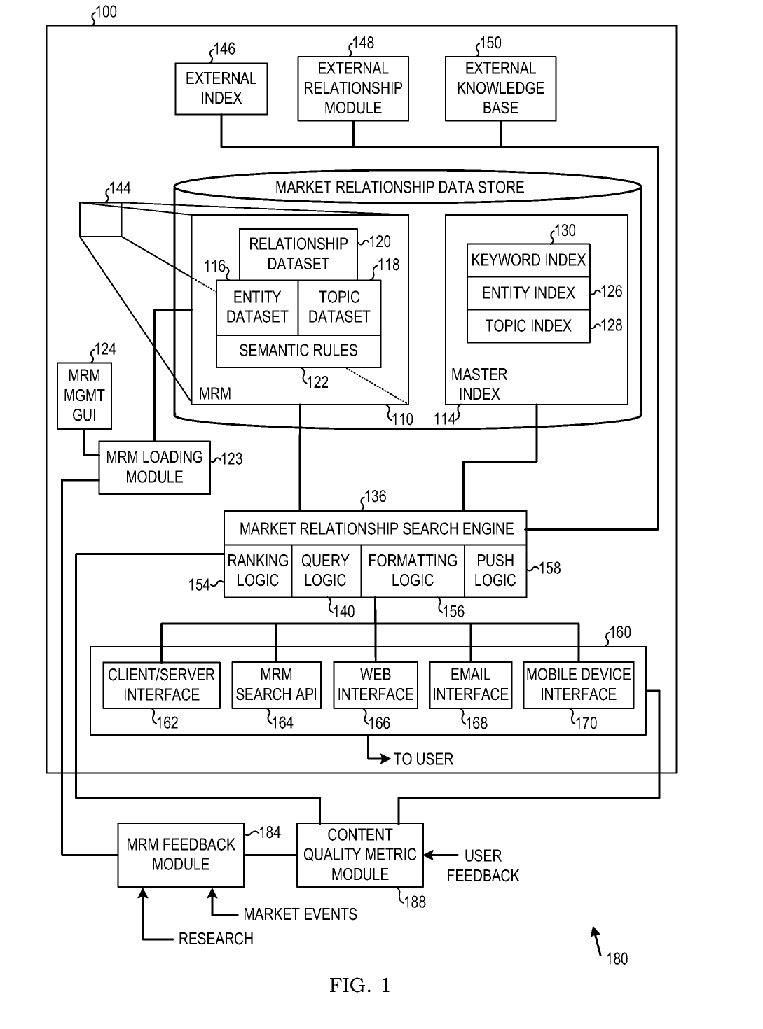

FIG. 1 illustrates an example apparatus 100 and system 180 according to various embodiments of the invention. Example embodiments described herein extract information content that has been identified and categorized from unstructured data according to a user's specific needs and interests. Various embodiments operate to create an information relationship model according to the user's needs and interests, to collect content segments from an unstructured data source, and to find relevant market entities and market topics in the unstructured data using the information relationship model.

The term “content segment” as used herein may comprise an information content file, a portion of a content file, a tag associated with a content file, or a result of a translation operation performed on a content file. A content file may comprise a markup language page (e.g., hypertext markup language), a text file, a word processing file, a graphics file, a video file, an audio file, a spreadsheet file, a slide presentation file, or a page description file. Content segments may be extracted from an internet, an intranet, a database, or a content stream.

Queries, including queries formulated using elements from the information relationship model, may be executed against a previously-assembled content index. The content index is created by indexing the relevant market entities and market topics and relevant keywords along with locations within the content segments wherein the market entities, market topics, and keywords may be found. Using these structures, the embodiments operate to timely match information to interests in a scalable manner.

Embodiments may be described herein in the context of specific examples or lists of market entities, market topics, and market relationships, some related to business and financial market relationships. It is noted that such lists are not exhaustive. Many other market entities, market topics, and market relationships associated with various subjects and with various information content sources are comprehended by the disclosed embodiments, as will be apparent to those skilled in the art.

The apparatus 100 comprises a market relationship data store (MRDS) 106. The MRDS 106 may include a market relationship module (MRM) 110 and a master index 114. The MRM 110 comprises one or more of a relational database, an eXtensible Markup Language (XML) schema, an object oriented database, a semantic database, or a resource description framework (RDF) data store. In some embodiments the MRM 110 may include a market entity dataset 116, a market topic dataset 118, a market relationship dataset 120, and a set of semantic rules 122. The MRM relates two or more market entities, two or more market topics, or one or more market entities and one or more market topics according to one or more market relationships.

The set of semantic rules 122 may be used to identify market entities and market topics in a content segment using a variety of semantic classification techniques known to those skilled in the art, including but not limited to statistical, probabilistic, taxonomic, hierarchical, heuristic, and/or machine learning categorization techniques.

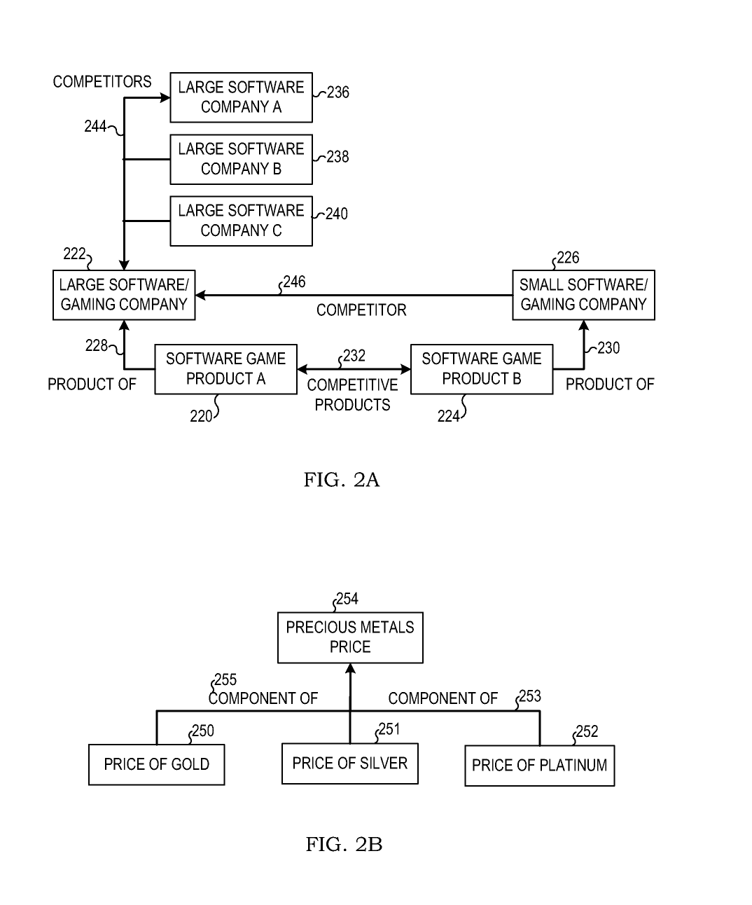

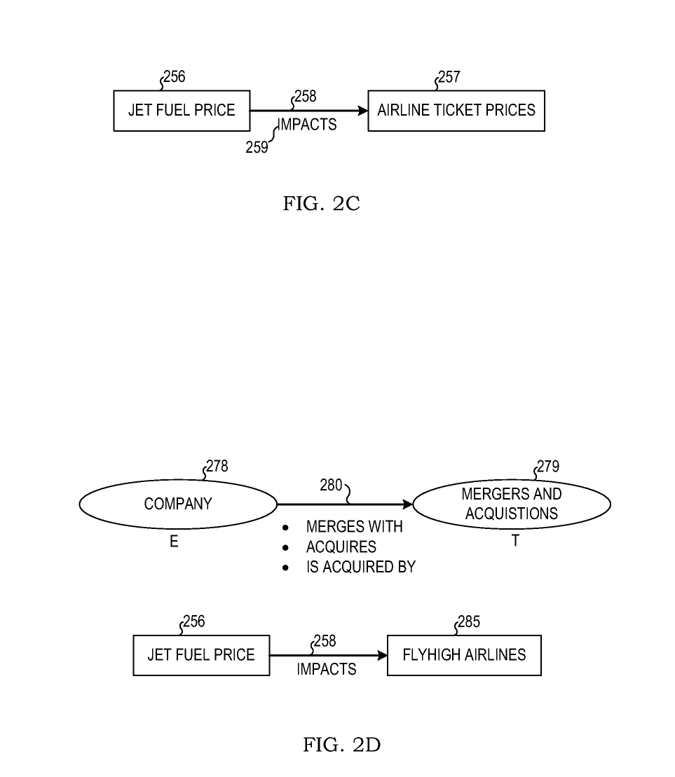

FIGS. 2A-2D illustrate example market entities and market topics in representative market relationships with one another according to various embodiments of the invention. Considering FIGS. 2A-2D in light of FIG. 1, market relationships contemplated herein may exist between two or more market entities, between two or more market topics, or between one or more market entities and one or more market topics. The market entities, market topics, and market relationships depicted herein are merely examples of the many varied market entities, market topics, and market relationships that may be included in the MRM 110 according to various embodiments and as needed by various users. Text strings mentioned in the foregoing examples may be, but need not be, used by various embodiments to parse relevant content from a set of content segments.

FIG. 2A shows an example set of market entities and market relationships. Some market relationships may be unidirectional and some bidirectional. Embodiments herein utilize the property of directionality of market relationships to more accurately model real-world market relationships. For example, the software game product A 220 is a product of a large software and gaming company 222. The software game product B 224 is a product of a small software gaming company 226. These market relationships are represented by the unidirectional arrows 228 and 230. The software game products 220 and 224 exist in a “competitive products” market relationship with each other, represented by the bidirectional arrow 232.

The large software and gaming company 222 and the large software companies 236, 238, and 240 are competitors. Analyzed from the perspective of the large software and gaming company 222, the large software companies 236, 238, and 240 are important competitors. Analyzed from the perspective of the large software companies 236, 238, and 240, the large software and gaming company 222 is an important competitor. These competitive market relationships are represented by the bidirectional, multi-headed arrow 244. On the other hand, the small software and gaming company 226 is not considered by the large software and gaming company 222 as a significant competitor. From the perspective of the small software and gaming company 226, however, the large software and gaming company 222 is a significant competitor. The unidirectionality of this competitive market relationship is represented by the arrow 246.

Embodiments herein may treat market relationships between market topics as hierarchical or associative. For example, FIG. 2B shows that the price of gold 250, the price of silver 251, and the price of platinum 252 may lie in a hierarchical market relationship 253 with a precious metals price 254. The precious metals price 254 may comprise the price of gold 250, the price of silver 251, and the price of platinum 252. The market relationship 253 may be represented by the text string “component of” 255 or similar.

FIG. 2C is an example of an associative market relationship between market topics according to embodiments herein. Jet fuel price 256 may increase, resulting in an increase in airline operating costs. The airlines are likely to pass such cost increases on to airline customers in the form of higher airline ticket prices 257. The market topics jet fuel price 256 and airline ticket prices 257 are related in this example by the market relationship 258. The market relationship 258 may be represented by “impacts” 259 or a similar text string.

A market entity may also be related to a market topic according to a market relationship. For example, a company 278 may be related to the corporate market topic “mergers and acquisitions” 279 according to a market relationship 280. The market relationship 280 may be represented by the text strings “merges with,” “acquires,” or “is acquired by.” In a further example, the market topic “jet fuel price” 256 may be related to an example market entity “Flyhigh Airlines” 285 according to the market relationship “impacts” 258.

Turning back now to FIG. 1, market relationships contemplated by the various embodiments may be static or dynamic. Static market relationships may be established by loading market relationship data structures into the MRM 110 prior to initiating relevant content retrieving operations as described hereinunder. The MRM 110 may be configured to store a dynamic market relationships established “on-the-fly” in response to market events or to a frequency of occurrence of particular entities or topics as relevant content is retrieved after initially loading the MRM 110. A market event as used herein means an occurrence at a given place and at a given time relating to a market entity or to a market topic, wherein the occurrence is sufficiently noteworthy to warrant some degree of coverage on the Internet.

Assume that an example web search engine company competes in the marketplace with other web search engine companies. These web search engine companies may be related by the MRM 110 as competitors. The example web search engine company may be unrelated by the MRM 110 to any company in the market relationship of “competitor” other than the web search engine competitors. Subsequently a “market event” such as the acquisition of a security software company by the example web search engine company may occur. This may necessitate a revision of the MRM 110 to include security software companies as competitors to the example web search company.

A particular market entity or topic may not currently be related by the MRM 110 to a “primary” market entity. Some embodiments may track the frequency with which the particular market entity or topic is found in content segments referencing the primary market entity. Embodiments so equipped may create an on-the-fly market relationship between the primary market entity and the particular market entity or topic in the MRM 110. The MRM 110 may be configured to store a dynamic market relationship created if the frequency of coincidence between two market entities, two market topics, or a market topic and a market entity found in content segments associated with a content stream increases past a selected threshold.

The MRM 110 may also be configured to store a new market entity or market topic synthesized from two or more existing market entities and/or market topics. The market entities and/or market topics may appear within a particular context. In some embodiments the market entities and/or market topics may be provided at query time.

For example, consider a market topic of “management departures” and a market entity “Company A.” Querying using the logical AND of this market topic-market entity combination returns content segments related to both “management departures” and “Company A.” However only a subset of the returns will be on target as “management departures from Company A.”

Some embodiments herein may create a new, context dependent market topic. In this example, the new market topic is “management departures from Company A.” A query using the new market topic returns the desired targeted subset, “management departures from Company A.” The new market topic behaves like other market topics in that it is associated with a semantic rule and it gets indexed; however it is built from pre-defined entities and topics and their associated semantic rules 122 stored in the MRM 110.

A new context-dependent market entity may also be created by combining two or more market entities or a market entity and a market topic. For example, the market entity “famous chief executive officer (CEO)” in context with the market entity “Company A” may result in the new market entity “famous CEO of Company A.” Likewise, the same market entity “famous CEO” in context with the market topic “philanthropy” may result in the new market entity “famous philanthropic CEO.” These logical structures enable the filtering out of results extraneous to a selected compound market entity or market topic.

Embodiments herein may identify key sets of classes for context types (e.g., management departure FROM, litigation BY, and litigation AGAINST, among others). Some embodiments may build a set of semantic rule “couplers” to couple multiple instances of an underlying market entity or market topic that is part of a new context-dependant market entity or market topic in the same way if the multiple instances share the same context type. Embodiments herein may also identify some market entities and market topics as “context capable” and may allow a user to supply the context at query time. Appropriate semantic logic may couple the market entity and/or market topic to existing semantic rules. A resulting compound, context-dependent market entity and/or market topic may then operate to categorize content segments.

A market entity may thus comprise one or more of a company, a subsidiary, a joint venture, a product brand, a service brand, a product application, a service application, a non-profit organization, an advocacy group, a region, a governmental sub-division, a person, a raw material, or a component. A market entity may also comprise a production plant or a location associated with one or more of a company, a subsidiary, a joint venture, a product brand, a service brand, a product application, a service application, a non-profit organization, an advocacy group, a region, or a governmental sub-division, among others.

A market topic may comprise one or more of a financial market topic, a corporate market topic, a macroeconomic market topic, a regulatory market topic, a geo-political market topic, or a thematic market topic, among others. Example financial market topics may include raw material prices, the credit quality of the debt of a particular corporation, and dividend rates associated with stock issued by a particular corporation, among others. Example corporate market topics may include management hires, management departures, mergers and acquisitions, and new product launches, among others. Example macroeconomic market topics may include gross domestic product (GDP) growth trends, federal interest rates, bond market yield curves, and globalization trends, among others. Example regulatory market topics may include federal tax rules for publicly-traded partnerships and foreign government regulation of direct marketing in a foreign country, among others. These examples of market topics and market topic categories are merely examples of many known to those skilled in the art and included in embodiments herein.

A market relationship between two entities may comprise one or more of customer, competitor, supplier, partner, subsidiary, parent company, merger and acquisition target, investor, regulator, banker, financier, employee, labor, lobbying group, advocacy group, industry consortium, union, management team member, director, thought leader, person of influence, financial analyst, industry analyst, division, office, plant, producer, seller, development resource, embedded resource, place of operation, key market, or location of unit, among others. A “thought leader” is a person who is a recognized authority in a particular field.

Embodiments herein also comprehend market relationships between two or more market topics and between one or more market entities and one or more market topics. A market relationship between a market entity and a market topic may derive from the methodology used to select the market entity and the market topic. The market relationship may be associated with a potential impact on the market entity of information related to the linked market topic. If the topic is constructed in a neutral way (e.g., the market topic “supply of pulp” related to a paper manufacturing market entity), the market relationship may simply comprise “important variable of,” or the like. On the other hand, if the market topic is constructed to be something like “pulp supply shortage,” the market relationship may comprise “introduces risk for,” or the like.

Considering a further example, if the market topic is related to China's relaxing import restrictions on paper then the market relationship could be “increases demand for.” Given that market topics may be selected according to their financial impact on companies, embodiments herein may create market relationships between entities and market topics along risk/reward lines. A market topic may be defined to identify documents relating to risk or reward, or the market topic may be defined neutrally.

Like market entities, market topics connect to each other hierarchically or associatively. In a hierarchical market relationship a market topic is a complete subset of the other. For example, “outsourcing to India” may comprise a child of the parent market topic “outsourcing.”

Associative market topics comprise categories that connect to each other without a parent-child market relationship necessarily applying. “Big Company's market relationships with labor” is a market topic that may be connected associatively with “Big Company's public relations (PR) initiatives” because Big Company may launch some PR initiatives to counter negative image resulting from labor relations problems.

A directionality attribute may be associated with a market relationship as illustrated in some of the market relationship examples cited above. For example, a larger company in competition with a smaller company may be seen by the smaller company as competitor, while the smaller company may not be recognized at all by the larger company.

The apparatus 100 may also include an MRM loading module 123 coupled to the MRM 110. The MRM loading module 123 may load the market entity dataset 116, the market topic dataset 118, the market relationship dataset 120, or the set of semantic rules 122. An MRM management graphical user interface (GUI) 124 may be coupled to the MRM loading module 123. The MRM GUI 124 receives one or more of a set of market entity data, a set of market topic data, a set of market relationship data, or a set of semantic rules and writes these to the MRM 110.

The master index 114 comprises one or more of a market entity index 126, a market topic index 128, and a keyword index 130. Each entry within each index refers to a selected content segment. Each selected content segment is located at a content location corresponding to an associated content location identifier. The content location identifier comprises may comprise a uniform resource locator (URL), a file location, or a location of a portion of a file within the file, among other location identifiers.

Entries within the keyword index 130 include a keyword or a keyphrase, the corresponding content location identifier, and a content segment offset. The keyword or keyphrase is extracted from the corresponding selected content segment. Some embodiments may include a keyword association metric value associated with the keyword or keyphrase. The keyword association metric value indicates a frequency of occurrence of the keyword in a selected content segment. The metric may also be based upon a presence of the keyword in a headline associated with the selected content segment or an occurrence of the keyword with greater prominence than surrounding text. An occurrence of the keyword in a caption associated with a picture found within the selected content segment or a presence of the keyword in anchor text may also be used to calculate the keyword association metric value.

Each entry within the market entity index 126 includes one or more of a market entity identifier, a corresponding content location identifier, and a content segment offset. The market entity identifier corresponds to a market entity identified within a selected content segment using the MRM 110. The occurrence of the identified market entity in the selected content segment implies that the identified market entity is referred to by the selected content segment.

Each entry in the market topic index 128 comprises one or more of a market topic identifier, a corresponding content location identifier, and a content segment offset. The market topic identifier corresponds to a market topic selected using the MRM 110 and referred to by one or more selected content segments.

In some embodiments the master index 114 may be configured to store a strength of association metric value corresponding to the selected market entity and/or the selected market topic. The strength of association metric value indicates the degree of relatedness between the selected content segment and the selected market entity or the selected market topic, respectively. The strength of association metric value is computed using the set of semantic rules and is based upon one or more of a frequency of occurrence of the market entity or the market topic in the selected content segment, a presence of the market entity or the market topic in a headline associated with the selected content segment, an occurrence of the market entity or the market topic in a larger font size than surrounding text, or an occurrence of the market entity or the market topic in a caption associated with a picture found within the selected content segment.

The market entity index 126 and the market topic index 128 may also be configured to store an impact metric value associated with an impacted market entity or an impacted market topic, respectively. The impact metric value indicates the relative importance of the selected content segment to the impacted market entity or the impacted market topic. The impact metric value is calculated using the set of semantic rules and comprises a composite score. The composite score is based upon factors such as a pre-defined assessment of a financial impact of an impacting market entity or an impacting market topic found in the selected content segment on the impacted market entity or on the impacted market topic.

Other factors used to calculate the impact metric value may include an occurrence in the selected content segment of an impacting market entity or market topic pre-defined as high impact; an occurrence in the selected content segment of an impacting market entity-keyword pair, wherein the impacting market entity-keyword pair is pre-defined as high impact; an occurrence in the selected content segment of an impacting market topic-keyword pair, wherein the impacting market topic-keyword pair is pre-defined as high impact; an occurrence in the selected content segment of multiple key market entities; an occurrence in the selected content segment of multiple key market topics, and/or authorship of the selected content segment by a member of a predefined list of individuals determined through research to be at least one of a member of management, a thought leader, or an influential person in an industry.

The master index 114 thus stores a plurality of content location identifiers associated with a corresponding plurality of content segments. The content segments may have been parsed at an earlier time from unstructured information content according to the MRM 110. Each content segment is related by the master index to a selected market entity, a selected market topic, or a keyword.

The apparatus 100 may also include a market relationship search engine (MRSE) 136 coupled to the MRM 110. The MRSE 136 receives and services query task requests. Query logic 140 may be coupled to the MRSE 136 to perform a query against a query target. The query target may comprise the master index 114, the MRM 110, an MRM overlay 144, an external index 146, an external market relationship module 148, or an external database 150, among other targets.

The query logic 140 formulates the query using a keyword, a phrase, a market topic, a market entity, a market relationship, and/or a semantic rule and/or Boolean combinations of these. In some embodiments the query logic 140 may divide a query into several sub-queries for presentation to the MRSE 136. A result of one query may be used in the formulation of a subsequent query. A set of queries and/or sub-queries may be presented to the MRSE 136 sequentially or in parallel. Some embodiments may execute queries against external as well as internal targets. Some embodiments may accommodate user input to the query fields after the query has begun to be assembled by the query logic 140.

The query may return one or more of a list of market entities, a list of market topics, a list of market relationships, a list of semantic rules, a list of content segments, or a null (collectively, “returned information elements”).

The apparatus 100 may also include ranking logic 154 coupled to the MRSE 136. The ranking logic 154 ranks a list of returned content segments according to a content quality metric (CQM). Applicable CQMs include source type, content type, obscurity, incremental information, impact, and applicability of the returned information elements to a user requirement. Processes for measuring these CQMs are described further below. These processes may use the previously-described keyword association metric values (associated with keywords), strength of association metric values (associated with market entities and market topics), and impact metric values (associated with market entities and market topics) as input.

“Source type” is a CQM comprising a preselected value assigned to each of a number of content sources according to a perceived value of each of the content sources. For example, a particular user may rate major news sources such as The Wall Street Journal as a more valuable category of sources than press wires that publish company press releases.

“Content type” is a CQM comprising a preselected value assigned to each of a number of types of content according to the perceived value of each type of content. For example, a particular user may rate the content type “financial editorials” more highly than the content type “metro page articles.”

“Incremental information” is a CQM measure of the quantity of new information in a content segment relative to the information contained in content segments already received over some period of time. A user may place a higher value on content segments if the segments contain incrementally newer information as compared to information contained in earlier-received content segments. The incremental information CQM is calculated by comparing the text in a content segment with the text in earlier-received content segments using syntactic, semantic, linguistic and statistical techniques.

“Obscurity” is a CQM measure of how little-known information in a content segment is likely to be. Some users, including asset managers in the securities arena, may place higher value on some types of information if it is unlikely that the information is widely known. Obscurity is calculated from (a) a factor based upon internet link structure analysis of the content segment and the source of the content segment; and (b) the type of subject matter in the content segment, among other factors.

“Impact” is a CQM related to a perceived market impact of information contained in a content segment. For example, a content segment containing an announcement of a merger or an acquisition in the financial markets may be considered a high-impact content segment because such announcements often cause stock price increases or decreases. Scoring of the impact CQM is based upon heuristics associated with various market topics and market entities referred to by the content segment. The scoring may also be based upon issues raised by information contained in the content segment. The previously-described “impact metric values” associated with market entities and market topics referred to in a content segment may be used in scoring the impact CQM.

“Applicability to a user requirement” is a CQM measure of how closely a content segment matches user information requirements. User information requirements are derived from query task requests received by the MRSE from a user interface. The applicability to user requirements metric is calculated using the previously-described “keyword association values” associated with keywords contained in the query task request. The “strength of association metric values” associated with market entities and market topics included in the query task request are also used in calculating the applicability to user requirements metric.

The apparatus 100 may further comprise formatting logic 156 coupled to the MRSE 136. The formatting logic 156 formats the returned information elements for presentation at an information interface 160. The formatting logic 156 may logically order the returned information elements, including organizing the information according to logical divisions represented by the MRM.

The formatting logic may, for example, present identifiers associated with entities or topics mentioned in a content segment together with the content segment itself. The entity and/or topic identifiers may be presented to the user as “orbiters” organized around the content segment. Such a presentation may enable a user to discover new logical connections between MRM elements not already modeled in the MRM.

The formatting logic 156 may aggregate logically related information elements, may indent information elements according to a hierarchical market relationship between individual information elements, and/or may present an extracted summary of the information elements.

The apparatus 100 may also include push logic 158 coupled to the MRSE 136. The push logic 158 delivers the returned information elements to the information interface 160 according to a subscription request. The subscription request specifies an event-based trigger or a time-based trigger that is used to initiate delivery of the returned information elements to the user.

The information interface 160 may comprise one or more of a client-server interface 162, an MRM search application programming interface (API) 164, a World-wide Web interface 166, an email interface 168, or a mobile device interface 170. The information interface 160 is communicatively coupled to the MRSE to accept a query and to deliver a list of market entities, a list of market topics, a list of market relationships, a list of semantic rules, and/or a list of content segments in response to the query.

The following examples illustrate usage of the MRSE 136. Suppose that a user is interested in an example entity, say Company A. The user interacts with any of the information interfaces 160 to retrieve a list of competitors and suppliers associated with Company A. The information interface 160 sends a request to the MRSE 136. The MRSE receives the request and passes it to the query logic 156. The query logic 156 creates a query plan to query for entities that have a supplier or competitor relationship with Company A. The query plan may involve multiple queries accessing the relationship dataset 120 and the entity dataset 116 associated with the MRM 110. Apparatus and query languages associated with some embodiments may execute the query plan with a single query.

The relationship dataset 120 may then return a list of entities with supplier or competitor relationships to Company A. The entity dataset may provide details such as names for each returned entity. The formatting logic 156 may arrange the list of entities in an appropriate display. For example, it may separate competitors from suppliers. The formatted results may then be forwarded to the requesting information interface 160.

Considering another example of use of the MRSE 136, a user may want to see all management departures that have taken place from Company A. The information interface 160 may accept this task request from the user and send the request to the MRSE 136. The MRSE 136 may receive the task request and pass it to the query logic 140. The query logic 140 may then create a query plan to query for all content segments relating to management departures from Company A. The query plan may execute one or more queries; and the queries may access the entity index 126 and the topic index 128 associated with the master index 114.

The queries may use the set of semantic rules 122 associated with the context dependent topic of “management departures” to ensure that the list of returned content segments relates to the subset of management departures that includes only management departures from Company A. That is, management departures from some other company and/or management departures that are associated with company A in some way but that do not constitute management personnel leaving Company A are not included in the search results.

Some embodiments may calculate content quality metric values for content segments returned from the management departures query. The returned information may include details associated with each content segment including, for example, title, location, date, time, and tagged entities included in the content segment, among other details. The ranking logic 154 may then rank the returned content segments based upon various criteria including date, time, and content quality metric values, among other ranking criteria. The formatting logic 156 may format the ranked list for display. The formatted results may then be sent to the requesting information interface 160.

Considering a third example of use of the MRSE 136, some embodiments may support content delivery by subscription. A user may, for example, wish to receive all content found during the past 24 hours related to Company A at 7:00 a.m. each morning. The push logic 158 associated with the MRSE 136 triggers an action for the user subscription and issues a requests for all content segments found in the past 24 hours related to Company A.

The MRSE 136 receives the request and passes it to the query logic 140. The query logic 140 creates a query plan to retrieve all content segments meeting the compound criteria of having been indexed in the last 24 hours and being marked as associated with Company A. The query plan may typically involve a single query accessing the entity index 126 associated with the master index 114.

A list of content segments marked with Company A and indexed in the last 24 hours may be returned as a result. The resulting content set may have content quality metrics calculated for each content segment and may include content attributes such as the title of the content segment, location, date and time of indexing, entities tagged as being associated with a content segment and so forth as mentioned in previous examples. Content segments may also be ranked and formatted for display as previously described.

This example of subscription delivery is presented as a simplified example of push-based content delivery in the interest of clarity. Embodiments herein may support more complicated subscription delivery criteria used by the MRSE 136 to proactively deliver information to a subscribing user.

Taking a fourth example, assume that a user is browsing through content related to Company A. The user wants to see all content associated with competitors of Company A indexed during the past two weeks. The user issues the task request via one of the information interfaces 160. The MRSE 136 receives the task request and passes it to the query logic 140. The query logic 140 creates a query plan to retrieve all content segments marked as competitors of Company A that were indexed during the past two weeks. The query plan may involve multiple queries of the relationship dataset 120 and the entity dataset 116 associated with the MRM 110. The plan may also involve multiple queries of the entity index 126 associated with the master index 114.

First a query or a set of queries may retrieve a list of entities that are competitors of Company A. This part of the process is similar to the one described in the first example. A list of the returned entities comprising competitors of Company A may then be used as inputs to a second query. The second query may be issued to the entity index 126 for content segments indexed during the past two weeks and containing one or more of the competitive entities. The result of the second query may comprise a list of content segments related to competitors of Company A indexed during the past two weeks. Some embodiments may calculate content quality metrics, may return content segment attributes, may rank the returned content segments, and may format the content segments for display as previously described.

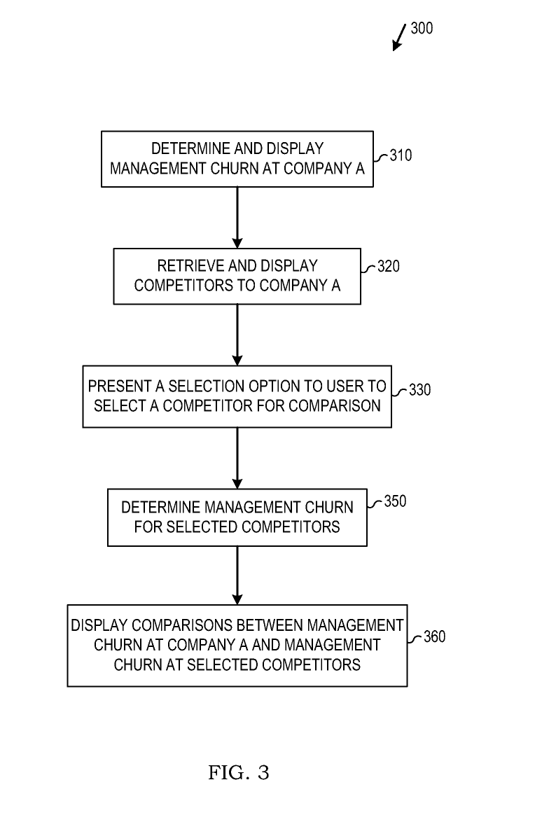

FIG. 3 depicts an example method 300 applicable to the area of securities asset management. A portfolio manager or research analyst may wish to analyze Company A. As a part of the analysis, the manager or analyst may wish to research management churn at Company A. They may also want to compare the management churn at Company A to the management churn at competitor companies to Company A. Such a comparison may provide insight into the stability of the management team at Company A in absolute and relative terms.

Embodiments herein may perform the research using a series of task requests similar to those described in the first and second examples. The method 300 may commence at block 310 with determining and displaying the management churn at Company A using a task request similar to that of the second example. The method 300 may also include retrieving and displaying a list of competitors to Company A using a task request similar to first example, at block 320. The method 300 may further include presenting a selection option to the user to select one or more competitors from the list of competitors, at block 330. Management churn at the user selected competitors may then be determined via query, at block 350. The method 300 may terminate at block 360 with displaying comparisons between the management chum at Company A and the management churn at the selected competitor companies using task requests similar to the second example.

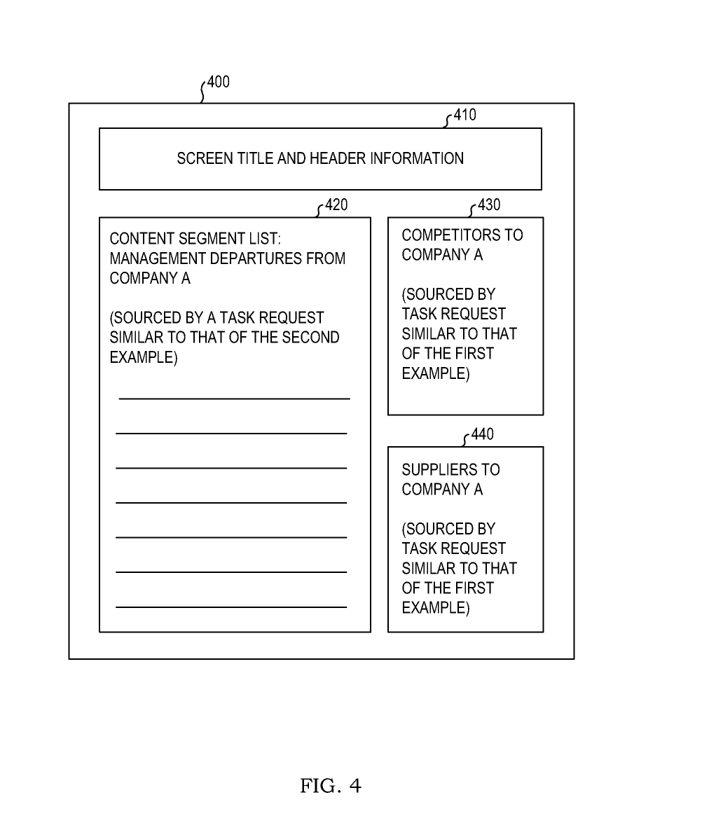

FIG. 4 illustrates an example user information presentation screen 400 according to various embodiments. The presentation screen 400 may result from the issuance of multiple task requests similar to those of the first and second examples above. The presentation screen 400 may be representative of a Web interface presentation screen or a client-server interface presentation screen.

The example presentation screen 400 may include a title and header area 410. A content segment list of management departures from Company A may be presented within an area 420 of the presentation screen 400. The content segment list may be similar to a list sourced by a task request like that of the second example. A list of competitors to Company A may be presented within an area 430 of the presentation screen 400. The list of competitors may be similar to a list sourced by a task request like that of the first example. A list of suppliers to Company A may be presented within an area 440 of the presentation screen 400. The list of suppliers may be similar to a list sourced by a task request like that of the first example.

Turning back to FIG. 1, a system 180 may include one or more of the apparatus 100. The system 180 may also include an MRM feedback module 184 communicatively coupled to the MRM 110. The MRM feedback module 184 may supply feedback data to the MRM loading module 123 to adjust elements of the MRM 110 as the system 180 is in use. The feedback data may include one or more of a content quality metric value associated with the returned information elements, market research data, or a market event.

A content quality metric module 188 may be coupled to the MRM feedback module 184. The content quality metric module 188 receives user feedback and measures one or more content quality characteristics associated with the returned information elements to derive the content quality metric value. Content quality characteristics may include recall, precision, content volume, source type, content type, obscurity, incremental information, impact, or applicability to user requirements.

It is noted that source type, content type, obscurity, incremental information, impact, or applicability to user requirements may apply to individual content segments. Content recall, precision, and volume, on the other hand, may apply to a set of content segments. It is further noted that user input may be required for the calculation of content recall and precision.

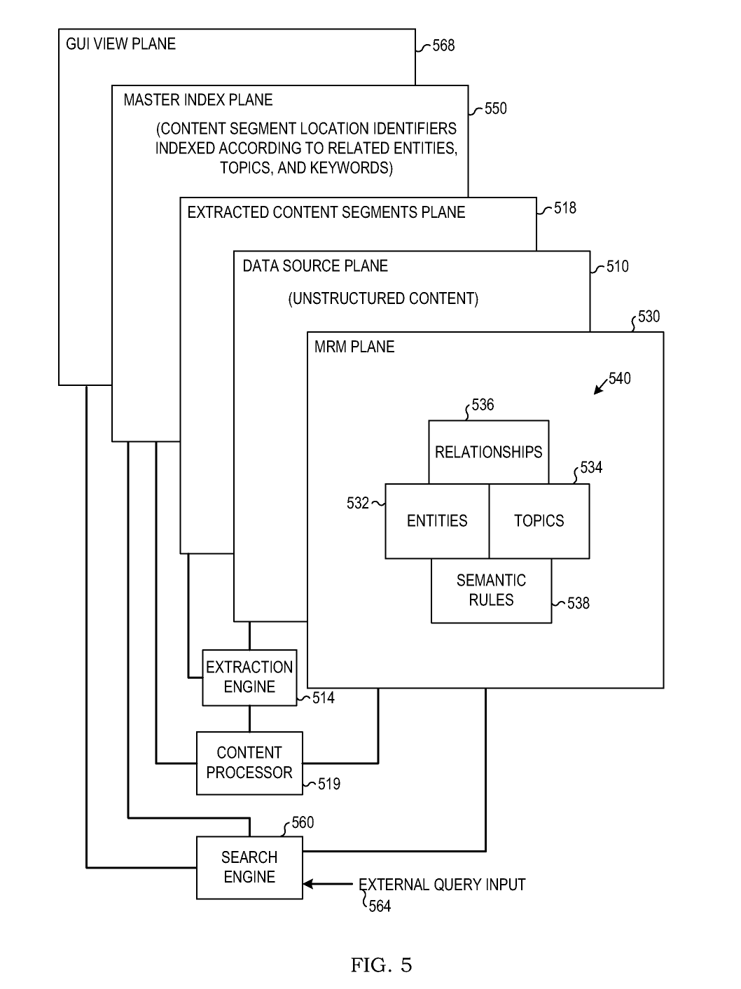

FIG. 5 is a data plane diagram conceptualizing market relationships according to various embodiments of the invention. A data source plane 510 represents a source of unstructured content from which content segments may be extracted. Such sources include the Web, one or more content files, a digitized library, and others as previously described. An extraction engine 514 extracts content from the data source plane 510 to yield information in an extracted content segments plane 518.

In an example embodiment the extraction engine 514 may comprise a web crawler (e.g., the linked content web crawling engine 134 of FIG. 1A). The information in the extracted content segments plane 518 comprises an unstructured subset of the data source plane content. In the case of web content, for example, the web crawler may be programmed to crawl a preconfigured set of websites. The web crawler may also perform basic filtering activities such as optionally removing titles, sub-headings, captions, and other page elements deemed to be of limited use in the extraction of relevant content. Content segments extracted by the extraction engine 514 are presented to a content processor 519.

An MRM plane 530 represents sets of market entities 532, market topics 534, market relationships 536, and semantic rules 538 that together form an IRM 540. The IRM 540 is used to determine which extracted content segments associated with market entities and market topics are indexed for subsequent retrieval. The IRM 540 may also optionally be used to formulate queries associated with the subsequent retrieval of indexed content segments. By customizing the IRM 540 to a specific user's content relevance requirements or to those of a particular class of users, the level of content recall, and/or precision may be increased relative to results achievable with a general search engine.

Increasing recall by including a wide set of related entities and topics may be particularly desirable when tracking a smaller entity with less coverage on the internet and other information channels. For example, some embodiments may include related entities and topics such as competitors, competing drugs, related therapeutic areas, labs where relevant research is being done, etc. when retrieving information about a small pharmaceutical company that is seldom mentioned in the media. Similarly, increasing precision by restricting related entities, sub-entities and topics to very important ones may be useful when searching for a company with a large amount of information coverage. For example, some embodiments may include only key divisions, product lines and executives of a large, much-covered company. This may operate to ensure that what is returned for that company has a high likelihood of being relevant.

The content processor 519 searches the extracted content segments plane 518 for information related to the market entities 532 and the market topics 534 using the semantic rules 538 from the MRM plane 530. The content processor 519 indexes locations of the resulting set of selected content segments by market entity, market topic, and keyword/keyphrase in a master index represented conceptually by the master index plane 550.

A temporal dimension is associated with the data planes 510, 518, and 550. The extraction engine 514 may perform extraction operations on the data source plane 510 and perform categorization operations by populating the master index plane 550 as one phase. A search engine 560 may subsequently perform search and retrieval operations on the master index plane 550 as a second phase.

The data source plane 510 may change dynamically over time as new content is made available and as old content is taken down. The degree of synchronism between the data source plane 510 and the master index plane 550 may thus be a function of the frequency of repeated crawling of websites associated with the data source plane 510. Embodiments herein may efficiently utilize crawling resources by narrowing the data source plane 510 to a list of crawled sites most likely to yield relevant content according to a user's particular content requirements.

At any point in time after an initial crawling and content processing cycle is performed according to the setup of the MRM plane 530 for a new user, the search engine 560 may formulate queries to be executed against the master index plane 550. The queries may be formulated using a combination of information from the IRM 540 and external query input 564. The external query input 564 may comprise input from a user, among other sources.

Thus formulated, the query may be executed against the master index plane 550 and/or the MRM plane 530. Selected content location identifiers returned from the master index plane 550 in response to the query may then be used to access the selected content for presentation to the user at a GUI view plane 568. The same mechanisms may return and present lists of relevant market entities, market topics, and market relationships.

A query may be formulated from keywords input using a traditional keyword search input interface. Some embodiments of the invention may also selectively present sub-structures of the MRM 110 to the user as a query composition tool. For example, a list of market topics defined by the MRM 110 as related to a subject company may be presented to a browsing user. The user may select one or more market entities from the list of market topics to be used as query criteria.

The MRM 110 may also be used to query other databases at runtime using semantic rules to dynamically categorize content. The MRM 110 may also be used to filter information in real time when the source is a content stream. Queries may also be saved for later execution. Some embodiments may retrieve and execute a saved query at selected intervals. Positive responses from such periodic queries may be delivered to the user in the form of an alerting function. Alternate embodiments may provide real-time alerting when the source is a content stream.

Any of the components previously described may be implemented in a number of ways, including embodiments in software. Software embodiments may be used in a simulation system, and the output of such a system may provide operational parameters to be used by the various apparatus described herein.

Thus, the apparatus 100; the MRDS 106; the MRM 110; the master index 114; the market entity dataset 116; the market topic dataset 118; the market relationship dataset 120; the set of semantic rules 122; the game products 220, 224; the arrows 228; the market relationships 253, 258, 280, 336; the market topics 279, 334; the prices 250, 251, 252, 254, 256, 257; the text string 255; the company 278; the market entities 285, 332; the MRM loading module 123; the MRM GUI 124; the market entity index 126; the market topic index 128; the keyword index 130; the MRSE 136; the query logic 140; the MRM overlay 144; the external index 146; the external market relationship module 148; the external database 150; the ranking logic 154; the formatting logic 156; the push logic 158; the interfaces 160, 162, 164, 166, 170; the presentation screen 400; the screen elements 410, 420, 430, 440; the system 180; the MRM feedback module 184; the content quality metric module 188; the data planes 510, 518, 530, 550, 568; the extraction engine 514; the content processor 519; the semantic rules 538; the market relationship model 540; the search engine 560; the external query input 564; and the GUI view plane 568 may all be characterized as “modules” herein.

The modules may include hardware circuitry, optical components, single or multi-processor circuits, memory circuits, software program modules and objects, firmware, and combinations thereof, as desired by the architect of the apparatus 100 and the system 180 and as appropriate for particular implementations of various embodiments.

The apparatus and systems of various embodiments may be useful in applications other than classifying and extracting unstructured data targeted to specific user interests and needs. Thus, the current disclosure is not to be so limited. The illustrations of the apparatus 100 and the system 180 are intended to provide a general understanding of the structure of various embodiments. They are not intended to serve as a complete or otherwise limiting description of all the elements and features of apparatus and systems that might make use of the structures described herein.

The novel apparatus and systems of various embodiments may comprise and/or be included in electronic circuitry used in computers, communication and signal processing circuitry, single-processor or multi-processor modules, single or multiple embedded processors, multi-core processors, data switches, and application-specific modules including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others. Some embodiments may include a number of methods.

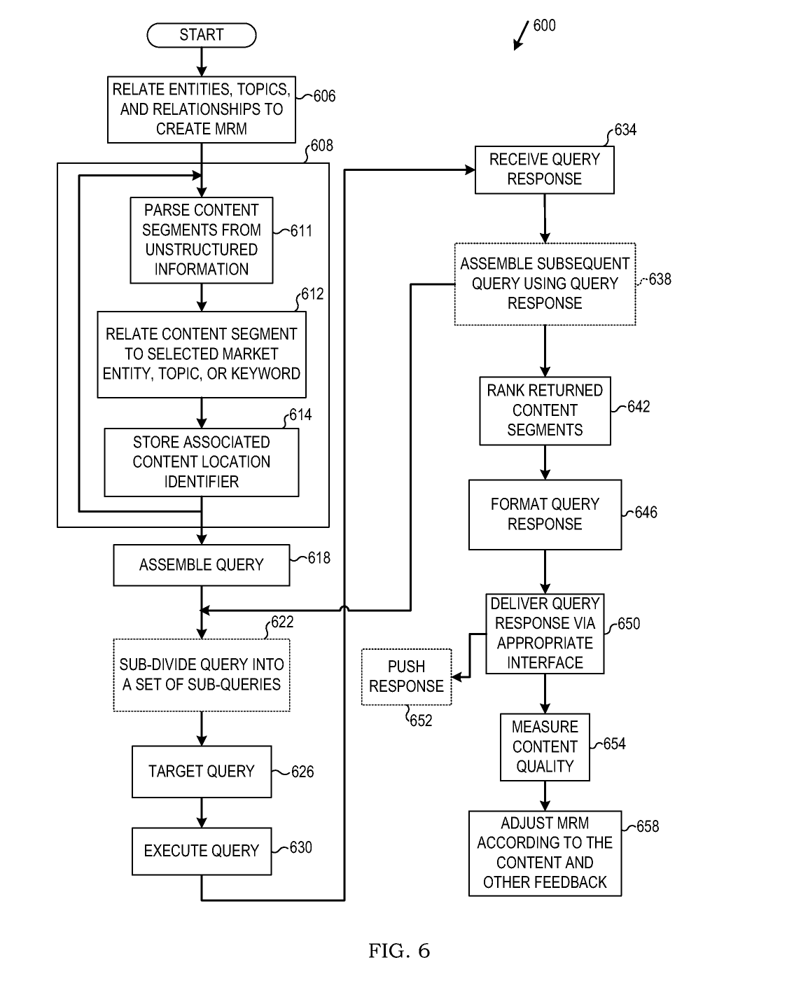

FIG. 6 is a flow diagram illustrating several methods according to various embodiments. A method 600 relates two or more market entities, two or more market topics, or one or more market entities and one or more market topics according to one or more market relationships using a market relationship module (MRM), at block 606.

Example market entities include a company, a subsidiary, a joint venture, a product brand, a service brand, a product application, a service application, a non-profit organization, an advocacy group, a region, a governmental sub-division, a person, a raw material, or a component. A market entity may also comprise a plant or a location associated with a company, a subsidiary, a joint venture, a product brand, a service brand, a product application, a service application, a non-profit organization, an advocacy group, a region, and/or a governmental sub-division.

A market topic may comprise a geo-political market topic, a financial market topic, a corporate market topic, a macroeconomic market topic, a regulatory market topic, or a thematic market topic.

Example market relationships include those of customer, competitor, supplier, partner, subsidiary, parent company, merger and acquisition target, investor, regulator, banker, financier, employee, labor, lobbying group, advocacy group, industry consortium, union, management team member, director, thought leader, financial analyst, industry analyst, division, office, plant, producer, seller, development resource, embedded resource, place of operation, key market, and/or location of unit.

The method 600 may continue by executing a recurring background process 608. The background process 608 may commence at block 611 with parsing two or more content segments from an unstructured information content source according to the MRM. The method 600 may also include relating each content segment to one or more of a selected market entity, a selected market topic, or a keyword, at block 612. The method 600 may further include storing a content location identifier associated with the content segment in a master index together with the associated market entity, market topic, or keyword, at block 614. The master index may comprise one or more of a market entity index, a market topic index, and a keyword index.

At any time after an initial iteration of the background process 608 the method 600 may continue with assembling one or more queries, at block 618. The query may use a keyword, a market topic, a market relationship, a phrase, a semantic rule, or a user-provided input as an argument. The method 600 may optionally include sub-dividing the query into a set of sub-queries, at block 622. The set of sub-queries may be executed in various combinations of serial and/or parallel order.

The method 600 may also include targeting the queries to a target query data source, at block 626. The target data source may comprise the master index, the MRM, an MRM overlay, an external index, an external market relationship module, or an external database. The queries may be executed against the master index, the MRM, the MRM overlay, the external index, the external market relationship module, or the external database, at block 630. “MRM overlay” as used herein comprises a user-specified subset of the MRM.

The method 600 may include receiving a response to the queries, at block 634. The response may comprise a list of market entities, a list of market topics, a list of market relationships, a list of semantic rules, a list of content segments, or a null return. Each entry in a list of returned content segments may include a list of market entities found in the content segment associated with the entry and a list of market topics found in the content segment associated with the entry. An entry in the list of content segments may also include a time of indexing and/or a source identifier.

The method 600 may optionally include assembling a subsequent query using the response to a prior query as an argument in the subsequent query, at block 638. However a query may be assembled, the method 600 may include ranking members of a set of content segments returned from the query according to a content quality metric, at block 642.

The method 600 may continue with formatting the response to the query for presentation at a user interface, at block 646. Formatting may include logically ordering the response to the query, organizing the response to the query according to logical divisions represented by the MRM, orbiting entities and/or topics in a presentation around the extracted content segment, aggregating a logically related group of content segments, indenting a group of content segments according to a hierarchical market relationship between individual content segments within the group of content segments, or presenting an extracted summary of the response to the query.

The method 600 may also include delivering the response to the query to an information consumer, at block 650. The query response may be delivered via a client-server interface, an MRM search application programming interface (API), a Web interface, an email interface, or a mobile device interface, among other interfaces. The method 600 may optionally include “pushing” the response to the query to an information consumer, at block 652. In this mode, the response to the query may be delivered to a user according to a subscription request previously made by the user. The subscription request may specify an event-based trigger or a time-based trigger.

The method 600 may continue at block 654 with measuring one or more content quality characteristics associated with the response to the query. The measurement may be used to derive a value of a content quality metric. The method 600 may also include adjusting the MRM according to the value of the content quality metric and/or other feedback, at block 658. Other feedback includes user feedback based upon extraction operations using the MRM, a market event, and/or a market research data point.

The activities described herein may be executed in an order other than the order described. The various activities described with respect to the methods identified herein may also be executed in repetitive, serial, and/or parallel fashion.

A software program may be launched from a computer-readable medium in a computer-based system to execute functions defined in the software program. Various programming languages may be employed to create software programs designed to implement and perform the methods disclosed herein. The programs may be structured in an object-oriented format using an object-oriented language such as Java or C++. Alternatively, the programs may be structured in a procedure-oriented format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

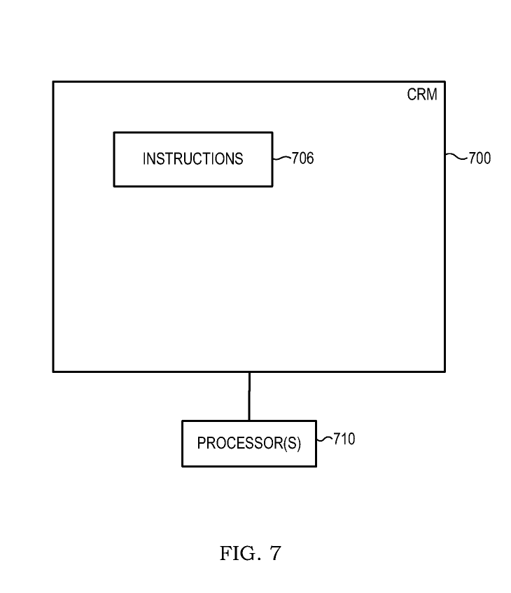

FIG. 7 is a block diagram of a computer-readable medium (CRM) 700 according to various embodiments of the invention. Examples of such embodiments may comprise a memory system, a magnetic or optical disk, or some other storage device. The CRM 700 may contain instructions 706 which, when accessed, result in one or more processors 710 performing any of the activities previously described, including those discussed with respect to the method 600 noted above.

The apparatus, systems, and methods disclosed herein operate to classify and extract unstructured data according to a user's specific needs and interests using an information relationship model. Relevant market entities, market topics, and keywords are indexed along with locations of relevant content segments wherein the market entities, market topics, and keywords may be found. Queries, including queries formulated using elements from the information relationship model, may be executed against the relevant content index. Query results may be filtered, formatted, and used as feedback to the MRM creation process. These structures may improve content recall in a scalable manner as compared to results obtained with traditional search engines.

The accompanying drawings that form a part hereof show, by way of illustration and not of limitation, particular embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense. The scope of various embodiments is defined by the appended claims and the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. § 1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, comprising:
a market relationship module (MRM) including a market entity dataset, a market topic dataset, a market relationship dataset, and a set of semantic rules, the MRM to relate at least one of a plurality of market entities, a plurality of market topics, or at least one market entity and at least one market topic according to at least one market relationship;
a master index to store a plurality of content location identifiers associated with a corresponding plurality of content segments, the plurality of content segments parsed from unstructured information content according to the MRM, each one of the plurality of content segments related by the master index to at least one of a selected market entity, a selected market topic, or a keyword; and
a market relationship search engine (MRSE) coupled to the MRM to receive a query task request and to service the query task request.

2. The apparatus of claim 1, wherein each of the plurality of market entities comprises at least one of a company, a subsidiary, a joint venture, a product brand, a service brand, a product application, a service application, a non-profit organization, an advocacy group, a region, a governmental sub-division, a person, a raw material, or a component.

3. The apparatus of claim 1, wherein each of the plurality of market entities comprises at least one of a plant or a location associated with at least one of a company, a subsidiary, a joint venture, a product brand, a service brand, a product application, a service application, a non-profit organization, an advocacy group, a region, or a governmental sub-division.

4. The apparatus of claim 1, wherein each of the plurality of market topics comprises at least one of a geo-political market topic, a financial market topic, a corporate market topic, a macroeconomic market topic, a regulatory market topic, or a thematic market topic.

5. The apparatus of claim 1, wherein the market relationship comprises at least one of customer, competitor, supplier, partner, subsidiary, parent company, merger and acquisition target, investor, regulator, banker, financier, employee, labor, lobbying group, advocacy group, industry consortium, union, management team member, director, thought leader, financial analyst, industry analyst, division, office, plant, producer, seller, development resource, embedded resource, place of operation, key market, or location of unit.

6. The apparatus of claim 1, wherein the at least one market relationship comprises a dynamic market relationship.

7. The apparatus of claim 1, wherein the MRM is configured to store a dynamic market relationship established in response to a market event after initially loading the MRM.

8. The apparatus of claim 1, wherein the MRM is configured to store a dynamic market relationship established if a frequency of coincidence between at least one of two market entities, two market topics, or a market entity and a market topic found in at least one of the plurality of selected content segments increases past a selected threshold.

9. The apparatus of claim 1, wherein the MRM is configured to store a new market topic synthesized from at least one of the plurality of market topics or the at least one market entity and the at least one market topic and wherein the plurality of market topics or the at least one market entity and the at least one market topic are provided at query time.

10. The apparatus of claim 1, wherein the MRM is configured to store a new market entity synthesized from at least one of the plurality of market entities or the at least one market entity and the at least one market topic and wherein the plurality of market topics or the at least one market entity and the at least one market topic are provided at query time.

11. The apparatus of claim 1, wherein the MRM comprises at least one of a relational database, an eXtensible Markup Language (XML) schema, an object-oriented database, a semantic database, or a resource description framework (RDF) data store.

12. The apparatus of claim 1, wherein the master index comprises at least one of a market entity index, a market topic index, and a keyword index.

13. The apparatus of claim 1, wherein each of the plurality of content segments comprises at least one of a content file, a portion of the content file, a tag associated with the content file, or a result of a translation operation performed on the content file.

14. The apparatus of claim 13, wherein the content file comprises at least one of a markup language page, a text file, a word processing file, a graphics file, a video file, an audio file, a spreadsheet file, a slide presentation file, or a page description file.

15. The apparatus of claim 1, wherein a content location identifier associated with each content segment comprises at least one of a uniform resource locator (URL), a file location, or a location of a portion of a file within the file.

16. The apparatus of claim 1, further comprising:
query logic coupled to the MRSE to perform a query against a query target using at least one of a query keyword, a query phrase, a query market topic, a query market entity, a query market relationship, a query semantic rule, or a user-provided input and to return at least one of a list of market entities, a list of market topics, a list of market relationships, a list of semantic rules, a list of content segments, or a null.

17. The apparatus of claim 16, wherein the query target comprises at least one of the master index, the MRM, an MRM overlay, an external index, an external market relationship module, or an external database.

18. The apparatus of claim 16, further comprising:
ranking logic coupled to the MRSE to rank members of a list of returned content segments according to a content quality metric.

19. The apparatus of claim 16, further comprising:
formatting logic coupled to the MRSE to format the at least one content segment for presentation at a user interface by performing at least one of logically ordering the at least one content segment, organizing the at least one content segment according to logical divisions represented by the MRM, presenting at least one of identifiers associated with entities mentioned in the at least one content segment or identifiers associated with topics mentioned in the at least one content segment together with the at least one content segment, aggregating a logically related group of content segments, indenting a group of content segments according to a hierarchical market relationship between individual content segments within the group of content segments, or presenting an extracted summary of the at least one content segment.

20. The apparatus of claim 1, further comprising:
push logic coupled to the MRSE to deliver the at least one content segment to a user interface according to a subscription request, wherein the subscription request specifies at least one of an event-based trigger or a time-based trigger.

21. The apparatus of claim 1, further comprising:
at least one of a client-server interface, an MRM search application programming interface, a World-wide Web interface, an email interface, and a mobile device interface communicatively coupled to the MRSE to perform at least one of accepting a query and delivering at least one of a list of market entities, a list of market topics, a list of market relationships, a list of semantic rules, a list of content segments, or a null result in response to the query.

22. The apparatus of claim 1, further comprising:
an MRM loading module coupled to the MRM to load at least one of the market entity dataset, the market topic dataset, the market relationship dataset, or the set of semantic rules.

23. The apparatus of claim 22, further comprising:
an MRM management graphical user interface (GUI) coupled to the MRM loading module to receive at least one of a set of market entity data, a set of market topic data, a set of market relationship data, or a semantic rules set and to write the set of market entity data, the set of market topic data, the set of market relationship data, or the semantic rules set to the MRM.

24. A system, comprising:
a market relationship module (MRM) including a market entity dataset, a market topic dataset, a market relationship dataset, and a set of semantic rules, the MRM to relate at least one of a plurality of market entities, a plurality of market topics, or at least one market entity and at least one market topic according to at least one market relationship;
a master index to store a plurality of content location identifiers associated with a corresponding plurality of content segments, the plurality of content segments parsed from unstructured information content according to the MRM, each one of the plurality of content segments related by the master index to at least one of a selected market entity, a selected market topic, or a keyword;
a market relationship search engine (MRSE) coupled to the MRM to receive a query task request and to service the query task request; and
an MRM feedback module communicatively coupled to the MRM to adjust elements of the MRM according to at least one of a content quality metric value associated with the at least one content segment, a market research data input to the MRM feedback module, or a market events input to the MRM feedback module.

25. The system of claim 24, further comprising:
a content quality metric module coupled to the MRM feedback module to receive user feedback and to measure at least one content quality characteristic associated with the at least one content segment to derive the at least one content quality metric value.

26. The system of claim 25, wherein the at least one content quality characteristic comprises at least one of recall, precision, content volume, source type, content type, obscurity, incremental information, impact, or applicability to user requirements.

27. A method, comprising:
relating at least one of a plurality of market entities, a plurality of market topics, or at least one market entity and at least one market topic according to at least one market relationship to create a market relationship module (MRM);
storing a plurality of content location identifiers associated with a corresponding plurality of content segments in a master index, the plurality of content segments parsed from unstructured information content according to the MRM, each one of the plurality of content segments being related by the master index to at least one of a selected market entity, a selected market topic, or a keyword; and
executing at least one query against at least one of the master index, the MRM, an MRM overlay, an external index, an external market relationship module, or an external database; and
receiving a response to the at least one query.

28. The method of claim 27, wherein each of the plurality of market entities comprises at least one of a company, a subsidiary, a joint venture, a product brand, a service brand, a product application, a service application, a non-profit organization, an advocacy group, a region, a governmental sub-division, a person, a raw material, or a component.

29. The method of claim 27, wherein each of the plurality of market entities comprises at least one of a plant or a location associated with at least one of a company, a subsidiary, a joint venture, a product brand, a service brand, a product application, a service application, a non-profit organization, an advocacy group, a region, or a governmental sub-division.

30. The method of claim 27, wherein each of the plurality of market topics comprises at least one of a geo-political market topic, a financial market topic, a corporate market topic, a macroeconomic market topic, a regulatory market topic, or a thematic market topic.

31. The method of claim 27, wherein the market relationship comprises at least one of customer, competitor, supplier, partner, subsidiary, parent company, merger and acquisition target, investor, regulator, banker, financier, employee, labor, lobbying group, advocacy group, industry consortium, union, management team member, director, thought leader, financial analyst, industry analyst, division, office, plant, producer, seller, development resource, embedded resource, place of operation, key market, or location of unit.

32. The method of claim 27, further comprising:
selectively establishing the market relationship as at least one of unidirectional or bidirectional.

33. The method of claim 27, wherein the MRM overlay comprises a user-specified subset of the MRM.

34. The method of claim 27, further comprising:
assembling the at least one query using at least one of a query keyword, a query market entity, a query market topic, a query market relationship, a query phrase, a query semantic rule, or a user-provided input as an argument.

35. The method of claim 27, further comprising:
sub-dividing the at least one query into a set of sub-queries; and
executing the set of sub-queries in at least one of a sequential order or a parallel order.

36. The method of claim 27, further comprising:
targeting the at least one query to at least one of the master index, the MRM, the MRM overlay, the external index, the external market relationship module, or the external database.

37. The method of claim 27, further comprising:
assembling a subsequent query using the response to the at least one query as an argument in the subsequent query.

38. The method of claim 27, wherein the response to the query comprises at least one of a list of market entities, a list of market topics, a list of market relationships, a list of semantic rules, a list of content segments, or a null.

39. The method of claim 38, wherein each entry in the list of content segments includes a list of market entities found in the content segment associated with the entry and a list of market topics found in the content segment associated with the entry.

40. The method of claim 38, wherein each entry in the list of content segments includes at least one of a time of indexing and a source identifier.

41. The method of claim 27, further comprising:
ranking members of a set of content segments returned from the at least one query according to a content quality metric.

42. The method of claim 27, further comprising:
delivering the response to the query to an information consumer via at least one of a client-server interface, an MRM search application programming interface, a World-wide Web interface, an email interface, or a mobile device interface.

43. The method of claim 27, further comprising:
pushing the response to the query to an information consumer by delivering the response to the query according to a subscription request, wherein the subscription request specifies at least one of an event-based trigger or a time-based trigger.

44. The method of claim 27, further comprising:
formatting the response to the query for presentation at a user interface by performing at least one of logically ordering the response to the query, organizing the response to the query according to logical divisions represented by the MRM, assembling at least one of identifiers associated with entities mentioned in the at least one content segment or identifiers associated with topics mentioned in the at least one content segment together with the at least one content segment, aggregating a logically related group of content segments, indenting a group of content segments according to a hierarchical market relationship between individual content segments within the group of content segments, or presenting an extracted summary of the response to the query.

45. The method of claim 27, further comprising:
receiving a set of market entity data, a set of market topic data, a set of market relationship data, and a semantic rules set; and
loading at least one of the market entity dataset, the market topic dataset, the market relationship dataset, or the set of semantic rules using at least one of the set of market entity data, the set of market topic data, the set of market relationship data, or the semantic rules set.

46. The method of claim 27, further comprising:
measuring at least one content quality characteristic associated with the response to the query to derive a value of a content quality metric; and
adjusting the MRM according to the value of the content quality metric.

47. A computer-readable medium having instructions, wherein the instructions, when executed, result in at least one processor performing:
relating at least one of a plurality of market entities, a plurality of market topics, or at least one market entity and at least one market topic according to at least one market relationship to create a market relationship module (MRM);
storing a plurality of content location identifiers associated with a corresponding plurality of content segments in a master index, the plurality of content segments parsed from unstructured information content according to the MRM, each one of the plurality of content segments being related by the master index to at least one of a selected market entity, a selected market topic, or a keyword; and
executing at least one query against at least one of the master index, the MRM, an MRM overlay, an external index, an external market relationship module, or an external database; and
receiving a response to the at least one query.

48. The computer-readable medium of claim 47, wherein the instructions, when executed, result in the at least one processor performing:
assembling the at least one query using at least one of a query keyword, a query market topic, a query market relationship, a query phrase, a query semantic rule, or a user-provided input as an argument; and
receiving at least one of a list of market entities, a list of market topics, a list of market relationships, a list of semantic rules, or a list of content segments in response to the at least one query.
